(19) United States
(12) Patent Application Publication
(10) Pub. No.: US 2002/0160345 A1
(43) Pub. Date: Oct. 31, 2002

(54) Child cup holder

(76) Inventor: Neyda M. Hempton, Loganville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/775,290

(22) Filed: Feb. 1, 2001

Related U.S. Application Data
(60) Provisional application No. 60/178,914, filed on Feb. 1, 2000.

(51) Int. Cl. G09B 19/00

(52) U.S. Cl. 434/258

(57) ABSTRACT

A child cup holder is disclosed that includes a cup portion; an attachment bar for attaching the cup portion to another object; plastic fingers disposed within the inner layer of the cup portion for holding a cup or bottle in place; an extruded polystyrene insulating foam disposed between the inner layer and the cover of the cup; a sound apparatus disposed between the inner layer of the cup and the cover of the cup; a power source disposed between the inner layer and the cover of the cup portion; a speaker disposed upon the cover of the cup portion; wires disposed between the inner layer and the cover, wherein the wires connect the power source and the sound apparatus and the sound apparatus to the speaker; a pressure activation button disposed upon the bottom portion of the cup portion and between the inner layer and the cover of the cup portion; and an activation button housing ring disposed around the activation button. Also disclosed is a method and system for teaching a child to replace a cup in a cup holder that includes the steps of providing a cup holder that plays a message when a bottle or child cup is removed from a cup holder, and providing a cup holder that plays a message when the bottle or child cup is replaced in the cup holder.

### CROSS-REFERENCE TO RELATED APPLICATIONS

This application claims priority to U.S. provisional patent application entitled “Cubby Cup” filed on Feb. 1, 2000 and accorded serial No. 60/178,914, which is entirely incorporated herein by reference.

### TECHNICAL FIELD

The present invention is generally related to a child cup holder and, more particularly, is related to a method for teaching children how to handle cups in vehicles.

### BACKGROUND OF THE INVENTION

Most parents are grateful when their infant gains muscle control of their upper limbs and are able to hold and control a bottle, usually at six to twelve months of age. This allows the caregiver additional time for other chores and nurturing tasks.

There is, however, a common occurrence shared among caregivers of infants and toddlers who can use a bottle or cup by themselves. Bottles, as well as children's spill-proof cups, are often dropped or thrown on the floor by the child. When the child is in a high chair, playpen or car seat, the parent must continually retrieve the cup or bottle. This can become stressful to the parent, especially while driving.

Families with infants or toddlers commonly use a car seat in which they secure their child. Being secured in a car seat can, however, create a problem. The child cannot retrieve items that have been dropped or thrown. Additionally, in a car seat, the child does not have a convenient location to place the cup or bottle. Thus, the cup or bottle ends up on the floor where it is no longer accessible. Not only is this frustrating for the child, it can be unnerving to the parent who is trying to drive. Moreover, efforts by the parent to retrieve and return the cup while driving are dangerous.

Thus, a heretofore unaddressed need exists in the industry to address the aforementioned deficiencies and inadequacies.

### SUMMARY OF THE INVENTION

The present invention provides a system and method for holding a child cup and teaching a child to replace its bottle or cup in a child cup holder.

Briefly described, in architecture, the system can be configured as follows. The child cup holder of the present invention includes a cup portion including an inner layer, a cover, a top portion and a bottom portion; an attachment bar for attaching the cup holder to a child car seat; plastic fingers disposed within the inner layer of the cup portion for holding a cup or bottle in place; an extruded polystyrene insulating foam disposed between the inner layer and the cover of the cup portion; a sound apparatus disposed between the inner layer and the cover of the cup portion; a power source disposed between the inner layer and the cover of the cup portion; a speaker disposed upon the cover of the cup portion; wires disposed between the inner layer and the cover; a pressure activation button disposed upon the bottom portion of the cup portion and between the inner layer and the cover of the cup portion; and an activation button housing ring disposed around the activation button. The cup holder may further include a cylinder attached to the cup portion, wherein the cylinder is configured to receive a threaded fastener; a wide band encircling the cup portion for attaching the cylinder to the cup portion; and an adjustable narrow band for attaching the cylinder to the wide band.

The present invention can also be viewed as providing a method for teaching a child to replace a bottle or child cup in a child cup holder. In this regard, the method can be broadly summarized by the following steps: providing a cup holder that plays a message when a bottle or child cup is removed from the cup holder, and providing a cup holder that plays a message when the bottle or child cup is replaced in the cup holder.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view diagram illustrating a child cup holder of the present invention, with one attachment option.

FIG. 2 is a side view diagram of the cup holder of FIG. 1.

FIG. 3 is a side view diagram of the cup holder of FIG. 1 with a different attachment option.

### DETAILED DESCRIPTION OF THE PREFERRED EMBODIMENT

The present invention is a battery-operated baby cup and/or bottle holder. The child cup holder would provide the child with a convenient location to place the cup or bottle while in a car seat or even a playpen, high chair or stroller. This device would be secured to the car seat at an area that would be readily accessible to the child. It would be designed primarily for use with car seats but would readily lend itself to use with other objects such as playpens, strollers and high chairs.

In car seats it is configured both as an after-market product, to be attached to existing car seats or other items such as those previously mentioned, and/or as original-equipment product, attached to the car seat or other items at the factory level.

The child cup holder could be portable, i.e., made to be attached to any existing car seat, stroller, playpen or high chair, or it may be made stationary, i.e., installed permanently by the manufacturer of the car seat, stroller, playpen or high chair.

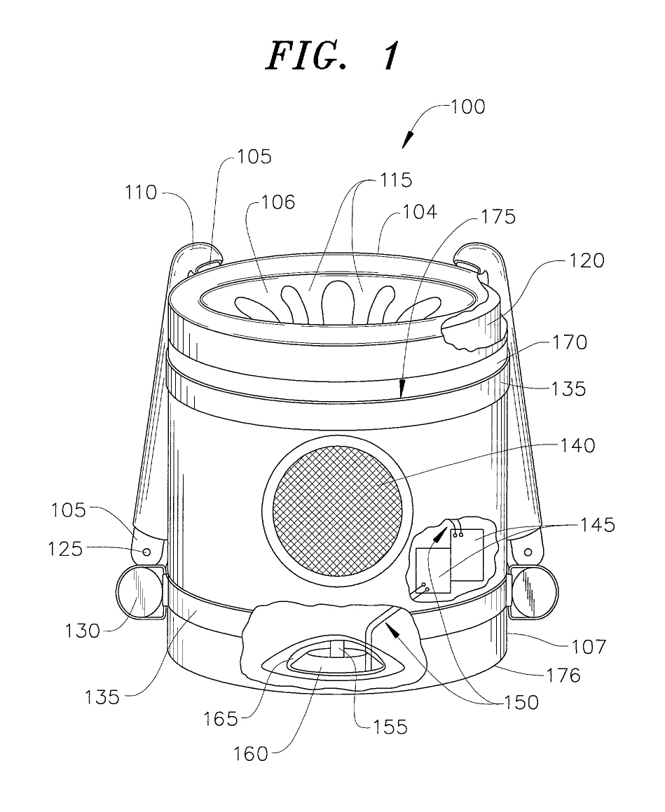

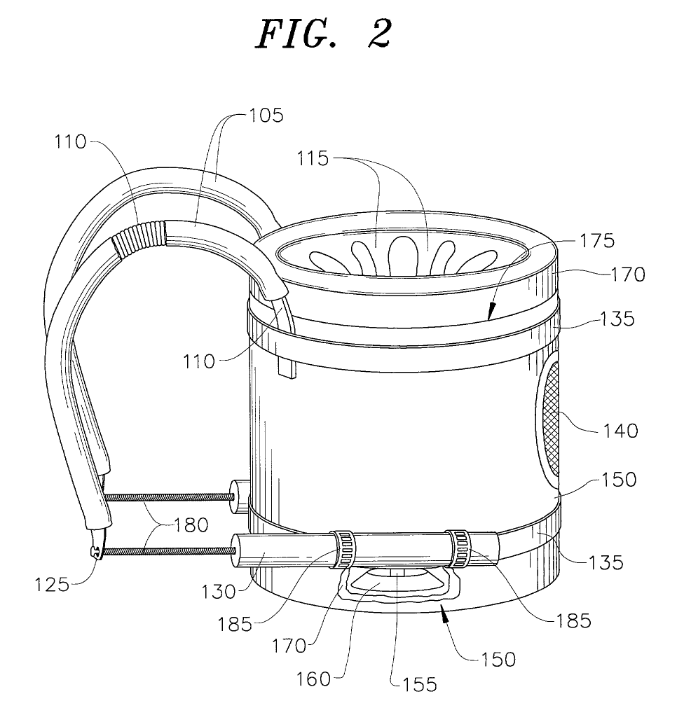

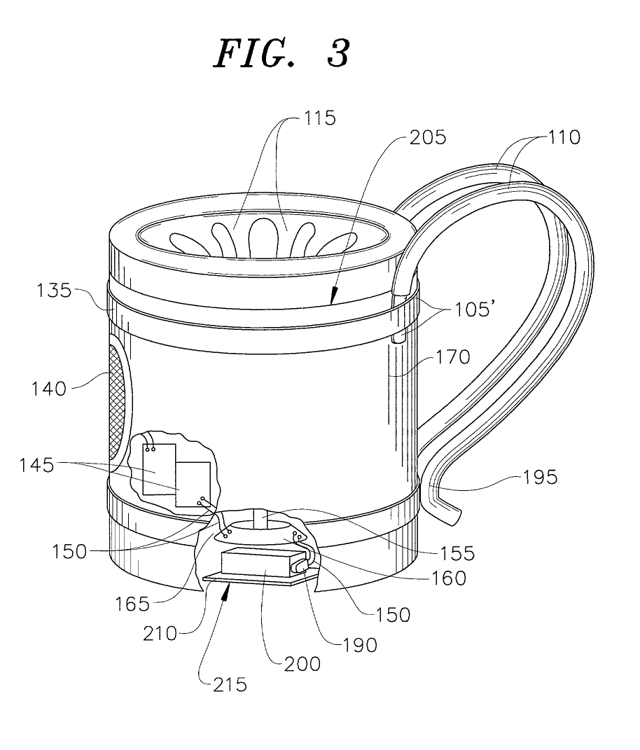

Depicted in FIGS. 1 and 2 are front and side views, respectively, of the child cup holder 100 of the present invention. The child cup holder 100 would be made of a soft plastic cover 170 for child safety and insulated with an extruded polystyrene insulating foam 120 to keep drinks cool or warm. The cup holder 100 includes a cup portion 104 that includes an inner layer 106, a cover 107, a top portion 175 and a bottom portion 176. The top portion 175 may be detachable. The child cup holder 100 would also feature soft plastic finger-like projections 115 inside the inner portion 106 to hold the child bottle or cup in place. It is designed to come apart at the attachment point 205 (see FIG. 3) for easy cleaning in such a way that when removing a top portion 175, the plastic fingers 115 could remain attached to the top portion 175.

The child cup holder 100 would also feature a powered sound apparatus 145, such as a sound chip, to occupy and entertain the child as well as to encourage placing the bottle or cup into it. It would use a dual speech mode; that is, it will be activated both by removing the cup or bottle and by replacing it. For example, as the cup is placed into the cup holder 100, the sound apparatus 145 would respond with the word “In,” and as the cup is removed it would say “Out.” When returned again, the sound apparatus 145 would say “Ahh that was good.” When removed again it would say “Still thirsty?” Once again returned, it would say “Ahh thank you,” and out again, “Have a drink.” The sayings of the sound apparatus 145 may be varied, and may include other language designed to encourage the child to use the cup holder 100 properly. The sound apparatus 145 of the child cup holder would be controlled by pressing and releasing a pressure activation button 155 at the bottom portion 176 of the cover 170, which may be kept waterproof by an optional rubber activation button cover 165. Disposed about the activation button 155 may be an optional activation button housing ring 160.

Also included within the scope of the cup holder 100 is that the sound apparatus 145 may work as a radio delay. Thus, when a cup is removed from the cup holder 100, the pressure activation button 155 at the bottom portion 176 of the cup portion 104 would be deactivated, thus triggering the sound apparatus 145 to begin playing either words or music. After a specified length of time, for example, but not limited to, one minute, the sound apparatus 145 ceases to produce a sound. The sound apparatus 145 would then only resume the production of a sound after the cup has been replaced in the cup holder 100 and the pressure activation button 155 is again activated. Thus, the effect is that when the radio stops playing, a child or other person could only get the radio to begin playing by replacing the cup in the cup holder 100.

Sound from the cup holder 100 may come from an optional speaker 140 disposed upon the cover 170 of the cup portion 104. The sound apparatus 145 may be connected to a power source 190 (see FIG. 3). As shown in FIG. 3, wires 150 may be disposed between the inner portion 106 of the cup portion 104 and the plastic cover 170 of the cup portion 104. The wires 150 may connect the sound apparatus 145 to the power source 190. Further, wires 150 may also connect the sound apparatus 145 to the speaker 140. As shown in FIG. 3, the power source 190 may be housed within a power source compartment 210 which may include an optional cover 215. The power source 190 may be, for example, but not limited to, a 9-volt battery 200.

The child cup holder 100 is designed to fit virtually any standard bottle or spill-proof cup and may be made of, for example, but not limited to, a soft fluorescent plastic material to enable the child to see it in the dark.

Components that may be used to produce the child cup holder include plastic, an extruded polystyrene insulating foam 120 and necessary hardware integral to the function of the cup holder 100 and the sound chip 145. Included within the scope of the child cup holder 100 are different materials, styles, sizes and shapes to better accommodate the various markets and consumer desires. The materials used to produce the child cup holder 100 are considered, for the most part, to be “off-the-shelf” type materials.

To secure the child cup holder 100 to a car seat or other object such as, for example, but not limited to, a playpen or high chair, at least two types of attachment apparatuses 105 and 105′ are included in the initial drawings, shown respectively in FIGS. 1 and 3. FIG. 1 depicts an adjustable attachment bar 105 that may be made of, for example, but not limited to, the metallic material commonly referred to as “Goose neck”-like, that is used on a microphone stand to allow flexibility of placement of the microphone. It may be covered with a soft plastic cover 110 for child protection. The attachment bar 105 may be fastened at the bottom portion 176 of the child cup holder 100 with a threaded fastener 180, including, for example, but not limited to, a wooden screw or metal screw, into a cylinder 130 with a receiver 125 for a threaded fastener, thus allowing adjustments to be made for each object to which the child cup holder 100 is being attached. The cylinder 130 may be attached to the cup portion 104 with a wide band 135, that may be made of, for example, but not limited to, a metal. The cylinder may be attached to the wide band 135 by a narrow adjustable band 185, that may also be made of, for example, but not limited to, a metal.

FIG. 3 depicts an alternative embodiment of the cup holder 100, that includes a bendable metal attachment bar 105′, that may be covered with a soft plastic 110 for child protection. This optional attachment bar 105′ may be used where the attachment bar 105 is impractical, such as in situations where there is no opening for the threaded fastener 180 to fit through. This attachment bar 105′ would leave the child cup holder hanging on the arm or crossbar of, for example, but not limited to, a car seat but with pressure from the attachment bar 105′ to hold it in place at the contact point 195 where the attachment bar 105′ comes in contact with the cup portion 104.

The child cup holder would be packaged in any or all of the following ways: packaged with no attachment bar 105 or 105′ and both attachment bars 105 and 105′ sold separately; packaged with both attachment bars 105 and 105′; or packaged in two separate packages allowing the buyer to choose one attachment bar 105 or 105′ or the other.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A child cup holder comprising:
a cup portion including an inner layer, a cover, a top portion, and a bottom portion;
an attachment bar for attaching the cup holder to a child car seat, wherein the attachment bar is fixedly attached to the cup portion;
plastic fingers disposed within the inner layer of the cup portion for holding a cup or bottle in place;
an extruded polystyrene insulating foam disposed between the inner layer and the cover of the cup portion;
a sound apparatus disposed between the inner layer and the cover of the cup portion, wherein the sound apparatus is configured to play a stored message;
a power source disposed between the inner layer and the cover of the cup portion;
a speaker disposed upon the cover of the cup portion;
wires disposed between the inner layer and the cover, wherein the wires connect the power source to the sound apparatus and the sound apparatus to the speaker;
a pressure activation button disposed upon the bottom portion of the cup portion and between the inner layer and the cover of the cup portion; and
an activation button housing ring disposed around the activation button.

2. The cup holder of claim 1, wherein the attachment bar comprises a receiver for a threaded fastener; and wherein the cup holder further comprises a cylinder fixedly attached to the cup portion, wherein said cylinder is configured so as to receive a threaded fastener.

3. The cup holder of claim 2, further comprising a wide band encircling the cup portion for attaching the cylinder to the cup portion.

4. The cup holder of claim 3, wherein the band is metal.

5. The cup holder of claim 2, further comprising an adjustable narrow band for attaching the cylinder to the wide band.

6. The cup holder of claim 1, wherein the attachment bar is bendable.

7. The cup holder of claim 1, wherein the cup holder further comprises a contact point where the attachment bar meets the cover of the cup portion when the cup holder is not attached to a child car seat.

8. The cup holder of claim 1, wherein the cup holder further comprises a foam cover for the attachment bar.

9. The cup holder of claim 1, wherein the cup holder further comprises a cover for the activation button.

10. The cup holder of claim 9, wherein the activation button cover is a waterproof material.

11. The cup holder of claim 1, wherein the top portion of the cup portion is detachable.

12. The cup holder of claim 1, wherein the cup holder further comprises a compartment for the power source disposed between the inner layer and the cover of the cup portion.

13. The cup holder of claim 12, wherein the power source compartment has a cover.

14. The cup holder of claim 1, wherein the power source is a nine-volt battery.

15. The cup holder of claim 1, further comprising a radio delay.

16. A method of teaching a child to replace a bottle or child cup in a child cup holder comprising the steps of:
providing a cup holder that plays a message when a bottle or child cup is removed from a cup holder; and
providing a cup holder that plays a message when the bottle or child cup is replaced in the cup holder.

17. The method of claim 16, further comprising the step of providing a radio delay in the cup holder such that the message played when the bottle or child cup is removed from the cup holder plays continuously for a short duration of time.

18. An apparatus for teaching a child to replace a bottle or child cup in a child cup holder while riding in a car comprising:
means for playing a message when a bottle or child cup is removed from a cup holder; and
means for playing a message when the bottle or child cup is replaced in the cup holder.
